(19) United States
(12) Patent Application Publication
(10) Pub. No.: US 2007/0247413 A1
(43) Pub. Date: Oct. 25, 2007

(54) Display Device

(76) Inventors: Junichi Maruyama, Yokohama (JP); Yoshihisa Ooishi, Yokohama (JP); Kikuo Ono, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/739,335

(22) Filed: Apr. 24, 2007

(30) Foreign Application Priority Data
Apr. 24, 2006 (JP) 2006-118685

(51) Int. Cl. G09G 3/36

(52) U.S. Cl. 345/101

(57) ABSTRACT

A display device includes an LUT storing circuit and an LUT holding circuit, a representative point selecting circuit, and a compensation amount calculating circuit. The storing and holding circuits store and hold not compensation amounts of all points but compensation amounts of representative points in a lookup table. The representative point selecting circuit refers to a compensation amount for a representative point in the lookup table and three representative points neighboring an interpolating object point for deriving a compensation amount of each interpolating object point except the representative points in the lookup table. The compensation amount calculating circuit calculates the compensation amount of each interpolating point except the representative points by performing an interpolating operation with respect to the compensation amounts of the three neighboring representative points.

The present application claims priority from Japanese application JP2006-118685 filed on Apr. 24, 2006, the content of which is hereby incorporated by reference into this application.

### BACKGROUND OF THE INVENTION

The present invention relates to a display device including a liquid crystal display device, an organic EL (Electro Luminescence) display device, a LCOS (Liquid Crystal On Silicon) display device, and so forth. More particularly, the present invention relates to a display device which is designed to compensate data to be outputted for display (which will be referred simply to as output display data) based on a temporal change in data to be inputted for display (which will be referred simply to as input display data) and to display the compensated output display data for the purpose of basically improving display quality of a moving image.

In the display device, some methods for improving quality of an image have been proposed which are designed to compensate output display data based on a temporal change of input display data and to display the compensated output display data. One of those methods is a method of reducing a response time of one of the liquid crystal elements constituting the liquid crystal display device.

The liquid crystal display device using the liquid crystal elements as a display unit has a shortcoming of bringing about the so-called blurredness phenomenon of a moving image resulting from a long response time of each liquid crystal element to change of a driving voltage and thereby lowering the display quality. For the purpose of overcoming this shortcoming about the slow response speed of the liquid crystal elements, a certain driving method has been known in which if it is grasped that a gradation of input display data of a current frame is higher (brighter) than a gradation of input display data of one previous frame on the basis of a difference of the input display data between the current frame and the one-previous frame, a correction value is added to the input display data of the current frame so that a higher driving voltage than the normal gradation voltage is supplied to a liquid crystal display panel, while if it is grasped that the former gradation is lower (gloomier) than the latter gradation on the basis of the difference therebetween, a correction value is added to the input display data of the current frame so that a lower driving voltage than the normal gradation voltage is supplied to the liquid crystal display panel. (Refer to U.S. Pat. No. 5,347,294 (corresponding to JP-A-4-365094). Hereafter, throughout the specification of the present application, this driving method is defined as an enhancement drive system or just an enhancement drive.

As means for calculating a correction value (hereafter, defined as a compensation amount in the present specification) in the enhancement drive system, a method has been known which method is designed to store in a lookup table a compensation amount derived by pre-operating a compensation amount for the display data of the current frame from the corresponding response times of the liquid crystal with the display data values of the current frame and the one-previous frame, obtain the compensation amount by referring to the lookup table, generate corrected display data by using the compensation amount, and then output the corrected display data. A further method has been also known which is designed to use a lookup table provided with the display data of the current frame and the one-previous frame as its inputs and with four middle corrections as its outputs for the purpose of reducing a capacity of a storing unit for the lookup table and then to calculate a compensation amount by performing an interpolating operation with respect to these four middle corrections. (Refer to US 2004/0189565 A1 (corresponding to JP-A-2004-310012).)

In the method of deriving a compensation amount by performing an interpolating operation with respect to the four middle compensation amounts described in US 2004/0189565 A1 (corresponding to JP-A-2004-310012), disadvantageously, the lookup table may be reduced in size and the capacity of a storing circuit for storing the lookup table may be reduced accordingly.

On the other hand, however, that method needs an operating circuit that performs a complicated interpolating operation. Further, the compensation amount calculated by performing an interpolating operation with respect to the four middle compensation amounts does not necessarily become a target value, so that unintentional noises may appear on the screen. For example, in the foregoing enhancement drive system, if the image data of the current frame is identical with that of the one-previous frame, that is, the still image data is inputted, the compensating process for stressing the change of the data is not necessary. Hence, it is preferable that the compensation amount becomes zero. However, in the case of the interpolating operation about four middle compensation amounts, the operation does not include a constraint in which the compensation amount is made zero if the data of the current frame is identical with the data of the one-previous frame. Hence, the compensation amount may take any value except zero in some combinations of four middle compensation amounts.

The foregoing condition requires the interpolating operation of four values to have a circuit for determining if the input display data represents a still image and the other circuit for making the compensation amount zero if it is determined that the input display data represents a still image, for the purpose of preventing occurrence of the noises. The interpolating operation of four values, therefore, makes the overall circuit complicated.

### SUMMARY OF THE INVENTION

It is an object of the present invention to provide a display device which is designed to use an interpolating operation for reducing a capacity of a lookup table for storing a compensation amount as well as implementing an interpolating operating circuit more easily in the display device provided with means for compensating output display data based on a temporal change in the input display data and displaying the compensated output display data, such as the enhancement drive system located in the liquid crystal display device.

According to an aspect of the invention, the display device is provided with the method taking the steps of storing compensation amounts of representative points in a lookup table, referring to the compensation amounts of the representative points stored in the lookup table, and calculating the compensation amounts of interpolating object points except the representative points by performing an interpolating operation with respect to the compensation amounts of the three representative points neighboring a point to be interpolated.

According to another aspect of the invention, the display device is provided with compensating means for compensating output display data on the basis of a temporal change in input display data and displaying the compensated output display data, such as an enhancement drive system, for improving display performance such as display quality of a moving image. Further, the display device provided with the compensating means may be constituted simply and less costly.

Other objects, features and advantages of the invention will become apparent from the following description of the embodiments of the invention taken in conjunction with the accompanying drawings.

### BRIEF DESCRIPTION OF THE DRAWINGS

FIG. 1 is a circuit diagram showing a configuration of a display device according to a first embodiment of the present invention;

FIGS. 2A to 2C are graphs showing change of input display data of the display device according to the first embodiment of the invention, output display data derived by implementing the enhancement drive with respect to the input display data, and lightness of the display device;

FIG. 3 is a table showing an exemplary structure of a lookup table for storing a compensation amount to be used for the enhancement drive of the display device according to the first embodiment of the present invention;

FIGS. 4A and 4B are views showing a system of performing an interpolating operation with respect to a compensation amount to be used for the enhancement drive of the display device according to the first embodiment of the present invention;

FIG. 5 is a view showing a conventional system of performing an interpolating operation with respect to a compensation amount to be used for enhancement drive of a display device;

FIG. 6 is a circuit diagram showing a configuration of a display device according to a second embodiment of the present invention;

FIGS. 7A to 7C are graphs showing change of input display data of the display device according to the second embodiment of the invention, output display data derived by implementing the enhancement drive with respect to the input display data, and lightness of the display device;

FIGS. 8A to 8C are graphs showing change of input display data of a display device according to a third embodiment of the present invention, output display data derived by implementing the enhancement drive with respect to the input display data, and lightness of the display device;

FIG. 9 is a view showing a system of performing an interpolating operation with respect to a compensation amount to be used for the enhancement drive of the display device according to the first embodiment of the invention; and

FIG. 10 is a view showing a system of performing an interpolating operation with respect to a compensation amount to be used for the enhancement drive of the display device according to the first embodiment of the invention.

### DESCRIPTION OF THE INVENTION

The description will be expanded with an example of the enhancement drive in the liquid crystal display device, which is described as an example of means for compensating the output display data based on the temporal change in the input display data and display the compensated output display data and a display device provided with the means.

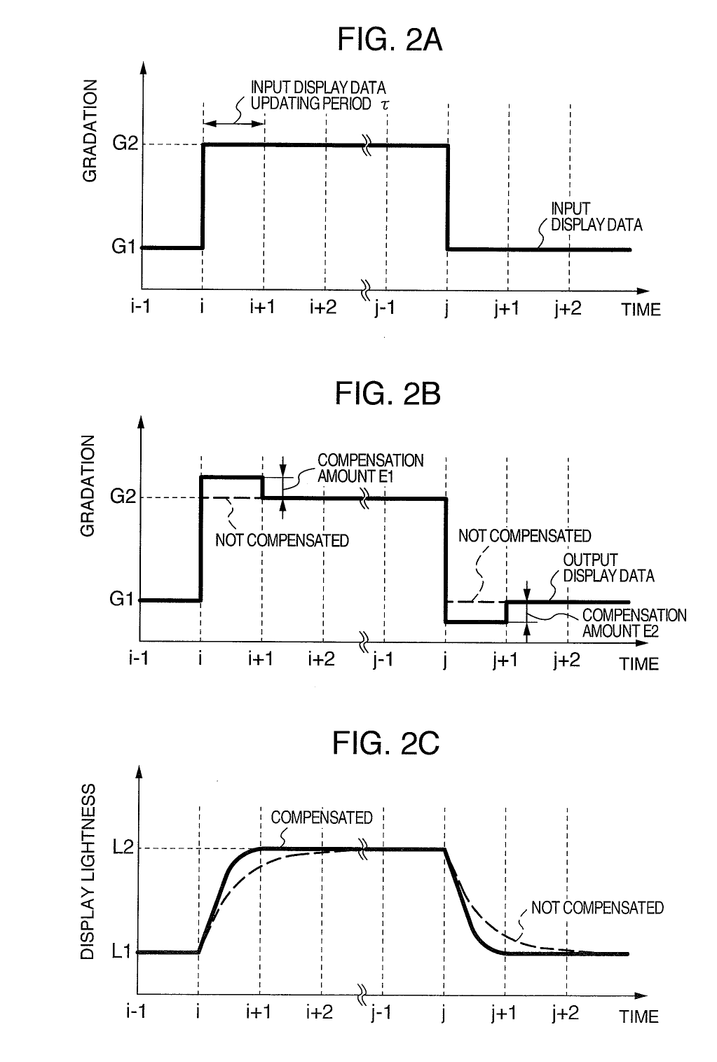

FIG. 2A is a graph showing change of display data to be inputted to a certain unit of display (one pixel) of the display device, in which an axis of abscissas denotes a time and an axis of ordinates denotes a gradation of the inputted display data. As illustrated in FIG. 2, the display data being inputted to the display device is sequentially updated at a predetermined length of time (that is, an updating period) τ. The updating period τ is, for example, 16.6 ms for the NTSC signal used for a television.

Hereafter, in the present specification, the updating period is defined as a frame period at which display data of one frame is switched. In general, the frame period corresponds to a period of a vertical synchronous signal.

In FIG. 2A, the input display data is changed so that in the (i−1)-th frame, the gradation G1 is given, in the i-th frame or later, the gradation G2 is given, and in the j-th frame or later, the gradation G1 is given again. i or j is an integer except 1. In response to the input display data, the display device supplies a gradation signal (for example, voltage) as follows. In the (i−1)-th frame, the display device supplies the gradation signal (for example, voltage) so that a lightness L1 for the gradation G1 may appear. In the i-th frame or later, the display device supplies the gradation signal so that a lightness L2 for the gradation G2 may appear. In the j-th frame or later, the display device supplies the gradation signal so that the lightness L1 for the gradation G1 may appear again. Hereafter, in the present specification, as described above, as an example, the driving method of driving the display device on a frame unit in response to the display data being inputted on a frame unit is defined as a normal drive or a normal drive system.

In succession, FIG. 2B exemplarily shows change of display data to be outputted to the display device (that is, the compensated display data to be outputted thereto) after the enhancement drive is carried out with respect to the inputted display data.

The waveform shown by a solid line represents change of the output data appearing in the case of applying the enhancement drive system to the display device. On the other hand, the waveform shown by a broken line represents change of the output data appearing when the display device is driven at a normal mode. For the enhancement drive, in the i-th frame, the gradation of the input data is changed from G1 to G2. Hence, for stressing this change, a compensation amount E1 is added. In the j-th frame, the gradation is changed from G2 to G1. For stressing this change, a compensation amount E2 is added. Herein, it is preferable to calculate the compensation amounts E1 and E2 in advance so that the lightness of the display device indicates a desired characteristic. For example, the compensation amount E1 is a positive value, while the compensation amount E2 is a negative value. The absolute value of the compensation amount E1 may be different from that of the compensation amount E2 and thus the absolute value of the compensation amount E1 may be greater than that of the compensation amount E2. For the waveform of the normal drive shown by a broken line, the output data is matched to the input data (before being compensated).

In turn, the description will be oriented to an example of a response characteristic of lightness of the output display data on a unit of display of the display device.

FIG. 2C exemplarily shows change of lightness of the output display data on a unit of display of the display device shown in FIG. 2B. The response of lightness of the output display data in the enhancement drive system and the response of lightness of the output display data in the normal drive system are plotted in the graph of FIG. 2C.

The waveform shown by a solid line indicates change of lightness on a unit of display about the output display data appearing in the case of applying the enhancement drive to the display device, while the waveform shown by a broken line indicates change of lightness on a unit of display about the output display data appearing in the case of applying the normal drive to the display system.

In the response of lightness in the case of the normal drive, shown by a broken line, in the i-th frame, the change of the display lightness is started to change from the lightness L1 to the lightness L2 but in the (i+1)-th frame, the display lightness does not reach the lightness L2. On the other hand, the response of lightness in the case of the enhancement drive, shown by a solid line, in the i-th frame, the display lightness is started to change from the lightness L1 to the lightness 12 but until the (i+1)-th frame the display lightness reaches the target lightness L2. That is, in a case that in the normal drive the lightness does not reach the target lightness within an updating period of τ, in the case of applying the enhancement drive to the display device, the properly compensated data is outputted to the display panel, so that the lightness may reach the target lightness within an updating period of τ. It means that an apparent response time of the display device may be reduced and thus the display quality of the moving image of the display device may be improved.

The foregoing description has concerned with the case that the enhancement drive system is applied to the liquid crystal display, which is a mere example of means for compensating the output display data based on a temporal change in the input display data and displaying the compensated output display data and a display device provided with the means.

In the present invention, a compensating means is provided for calculating a compensation amount E(p, q, r) of the r-th (r being a positive number) time used for compensating the input data D(q) at the q-th time from the input data D(p) at the p-th (p being an integer greater than or equal to 1) and the input display data D(q) at the q-th (q being an integer greater than or equal to 1), compensating the input data D(q) at the q-th time based on the compensation amount E(p, q, r) and supplying the output display data Do(r)=D(q)+E(p, q, r) at the r-th time and a display device for displaying the output display data D(r) supplied by the compensating means. The input display data D(p) at the p-th time may correspond to the input display data in the i-th frame and the input display data D(q) at the q-th time may correspond to the input display data in the (i+n)-th frame (i being an integer and n being an integer greater than or equal to 1).

The foregoing enhancement drive system liquid crystal display device has concerned with one embodiment of the display device in which the display device is designed to meet the relation of q=p+τ, r=q (τ being the updating period) and to derive the compensation amount E(p, q, r) based on the response characteristic of the display element so that a desired response time may be obtained in the transition between the gradations. The application of the present invention is not limited to this embodiment.

### First Embodiment

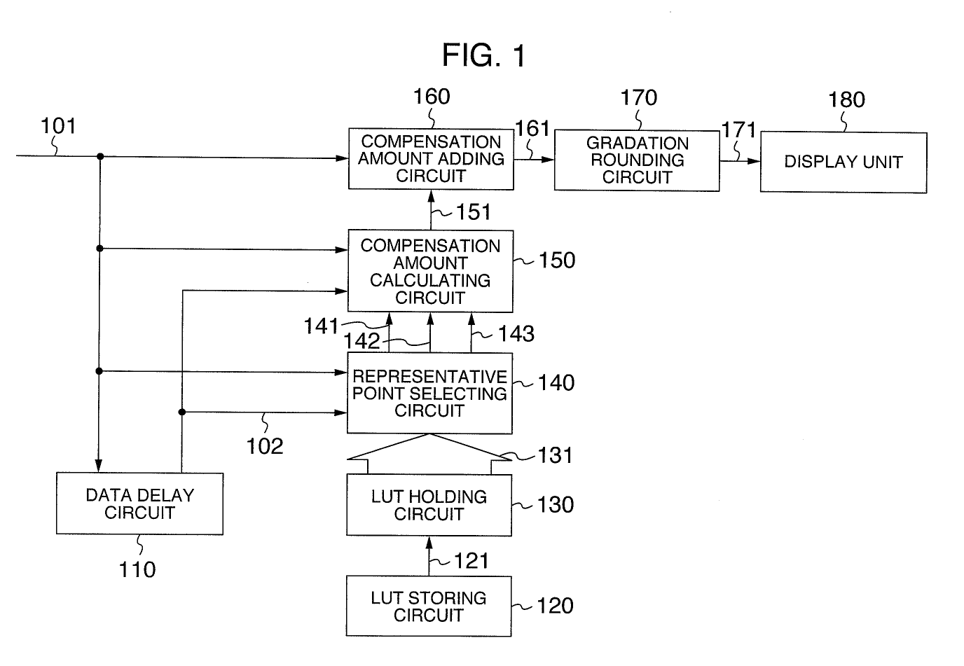

Hereafter, the first embodiment of the present invention will be described with reference to FIG. 1.

FIG. 1 shows a configuration of a display device to which one embodiment of the present invention is applied.

The display device provides a capability of being supplied as an input with display data 101 and displaying on a display unit 180 lightness and colors having been corresponded with the gradation of the input display data. The display device is designed to have a data delay circuit 110, an LUT storing circuit 120, an LUT holding circuit 130, a representative point selecting circuit 140, a compensation amount calculating circuit 150, a compensation amount adding circuit 160, a gradation rounding circuit 170, and a display unit 180.

The display data 101 is transferred from an external device (for example, the devices provided with a signal processing unit included in electronic apparatuses such as a TV receiver, a personal computer and a cellular phone).

The display unit 180 provides a capability of displaying lightness having been corresponded with the gradation of output display data 171 on the unit of display corresponding with the output display data 171 of the display device. It is preferable that the display unit 180 provides a display panel composed of pixels served as units of display, ranged in a matrix manner, a first driving circuit for outputting a display signal corresponding with the input display data to those pixels, and a second driving circuit for outputting to those pixels a selection signal for selecting the pixels to which the display signal is to be supplied.

As the display unit 180 is used a transmittance display unit that uses such display elements as having different light transmittances and realizes a plurality of gradations by corresponding those different transmittances with the gradations of the output display data 171, such as the so-called liquid crystal display device or LCOS display device. Instead, as the display unit 180 is used a reflective display unit that uses such display elements as having different reflectances and realizes a plurality of gradations by corresponding those different reflectances with the gradations of the output display data 171, such as the so-called electronic paper. Moreover, as the display unit 180 is used a light-emitting display unit that uses such display elements as having different degrees of emission and realizes a display of different gradations by corresponding the degrees of emission with the gradations of the output display data 171, such as the so-called organic EL display device, LED (Light-emitting Diode) display device or PDP (Plasma Display Panel) display device. Further, a display unit designed on another principle of display may be used as the display unit 180.

The data delay circuit 110 is a circuit for delaying the input display data 101 by a predetermined time. For example, a storing unit composed of various types of RAMs (Random Access Memories) may be used as the data delay circuit. For example, by controlling the storing unit so that the input display data 101 is written in the storing unit, held during a predetermined time, and then is read out on a proper timing, it is possible to obtain the input display data 102 delayed by a predetermined time. Herein, it is preferable that the capacity of the storing unit is large enough to realize the delay of the data by a predetermined time.

The LUT storing circuit 120 is a circuit for storing a lookup table of compensation amounts. For example, various types of nonvolatile memories such as a ROM (Read-only Memory), an EEPROM (Electrically Erasable Programmable ROM) and a flash memory may be used for the LUT storing circuit 120. The LUT holding circuit 130 is a circuit for holding a lookup table of compensation amounts and having a function of reading the lookup table out of the LUT storing circuit 120. The LUT holding circuit 130 is composed of a storage element group such as a register file and various types of RAMs and a control circuit for the storing circuit 120. A numeral 121 denotes the lookup table read out of the storing circuit 120.

It is preferable that the capacity of the LUT storing circuit 120 is greater than or equal to the holding capacity of the LUT holding circuit 130. For example, the display device may be preferably designed so that the LUT storing circuit 120 stores a plurality of lookup tables prepared in various conditions for calculating compensation amounts and then the LUT holding circuit 130 selects any one of those lookup tables, reads it out, and then uses it if necessary.

The representative point selecting circuit 140 is a circuit for selecting and supplying three representative points 141, 142, 143 based on the relation between the input display data 101 and the input display data delayed by a predetermined time by the data delay circuit 120 by referring to the lookup table 131 held in the LUT holding circuit 130.

The compensation amount calculating circuit 150 is a circuit for calculating the compensation amount 151 from the input display data 102 delayed by a predetermined time by the data delay circuit 120 and the three representative points 141, 143, 143 selected from the lookup table. The compensation amount 151 may be a positive or a negative value.

The compensation amount adding circuit 160 is a circuit for adding the compensation amount 151 to the input display data 101 and then supplying the compensated display data 161.

The gradation rounding circuit 170 is a circuit for supplying the output display data 171 compensated to be fitted in the displayable range of the display unit 180 if the compensated display data 161 departs from the displayable range of the gradations of the display unit 180. For example, the gradation rounding circuit 170 may be preferably designed so that if the compensated display data 161 is greater than the maximum gradation Gmax to be displayed on the display unit 180, the gradation Gmax is outputted as the output display data 171 instead of the compensated display data 161 or if the compensated display data 161 is smaller than the minimum gradation Gmin to be displayed on the display unit 180, instead of the compensated display data 161, the gradation Gmin is outputted as the output display data 171.

One configuration of the display device to which the present invention applies has been described above with reference to FIG. 1.

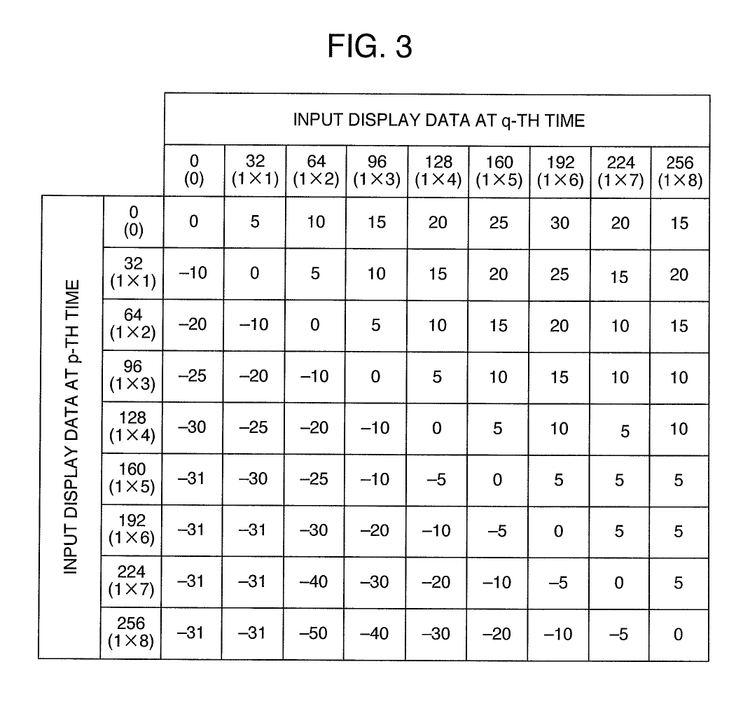

Then, one example of the lookup table that stores compensation amounts to be used for the display device of the present invention will de described with reference to FIG. 3.

FIG. 3 shows an example of the lookup table that stores the compensation amounts to be used for compensating the display data in the display device.

The lookup table is structured to store compensation amounts pre-calculated in correspondence with the combination of the input display data D(p) at the p-th time and the input display data D(q) at the q-th time. Letting G be the number of gradations to be inputted as the input display data or the number of gradations to be displayed on the display device, the lookup table is preferably composed so as to meet the relation of G=l×(N−1) wherein N representative gradation groups are selected for each l gradation and the representative point of the N-th row and the N-th column defined by the combination of the representative gradations is stored (G, l and N being an integer greater than or equal to 1).

FIG. 3 exemplarily shows the lookup table in the case of G=256, l=32 and N=9. In the table shown in FIG. 3, for example, in the case of D(p)=32 and D(q)=160, a value of 10 is derived as the compensation amount by referring to the lookup table. Or, for example, in the case of D(p)=224 and D(q)=64, a value of −40 is derived as the compensation amount by referring to the lookup table.

In the lookup table shown in FIG. 3, the number of rows is equal to the number of columns. Instead, these numbers may be different from each other. Further, the compensation amounts stored in the lookup table are not limited to the values indicated in FIG. 3. It is preferable to properly calculate those compensation amounts according to the characteristic of each display device for obtaining the target performance. Moreover, it is also preferable that the lookup table is composed to have a compensation amount of 0 in the case of D(p)=D(q). This is because it is determined that the case of D(p)=D(q) means the input display data with no change, that is, the data of a still image. In this case, no addition of the compensation amount is required. If the compensation amount is added to the data in this case, the quality of display is made lower, concretely, the display image is less stable and has noises like flickering or gradations mismatched to lightnesses.

In a case that the input display data D(p) at the p-th time is any one of the representative gradation groups and the input display data D(q) at the q-th time is also any one of the representative gradation groups, the compensation amount E(p, q, r) can be obtained at once by referring to the lookup table. On the other hand, in a case that one of the input display data D(p) at the p-th time and the input display data D(q) at the q-th time or both of them are not any one of the representative gradation groups, the neighboring representative compensation amount groups are selected from the lookup table and the compensation amount E(p, q, r) is calculated from these representative compensation amount groups by the interpolating operation (to be discussed below) (Hereafter, the point at which the compensation amount is calculated is called an interpolating object point.)

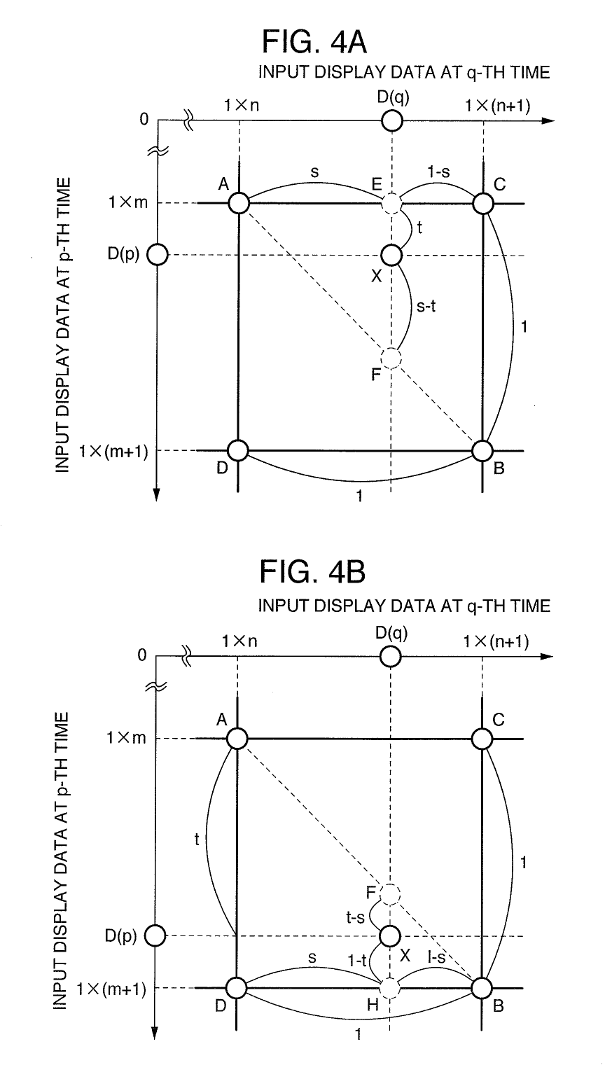

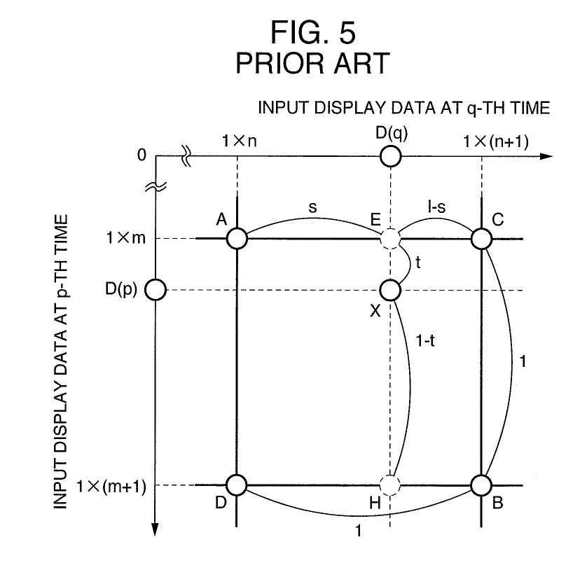

As can be seen above, one example of the lookup table that stores the compensation amounts to be used for compensating the display data in the display device of the invention has been described with reference to FIG. 3. In turn, the method for interpolating the compensation amount to be used in the display device of the invention will be described with reference to FIGS. 4, 9 and 10. Then, the difference between the compensation amount interpolating method and the conventional method for interpolating the compensation amount will be described with reference to FIG. 5.

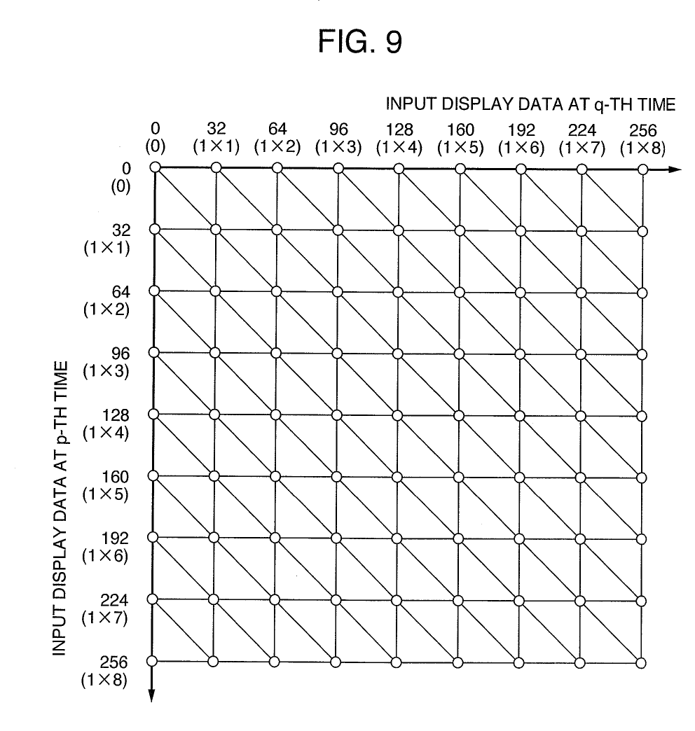

FIG. 9 diagrammatically illustrates the method for calculating a target compensation amount from a representative compensation amount group of a representative point group stored in the lookup table provided in the display device according to the present invention.

In the display device according to the present invention, as shown in FIG. 9, the two-dimensional plane having the input display data at the p-th time and the input display data at the q-th time as its axes is divided by triangular small areas, each area with three representative points stored in the lookup table as the vertexes, and the compensation amount of the points inside each small area are interpolated by the representative compensation amounts of three representative points surrounding a concerned point. Like the example shown in FIG. 3, FIG. 9 shows an example in which G=256, l=32 and N=9 are given.

Then, the interpolating method will be described in more detail with reference to FIG. 4.

FIG. 4 shows the method for interpolating the compensation amount from the three representative points obtained on the basis of the input display data D(p) at the p-th time, the input display data D(q) at the q-th time and the relation between D(p) and D(q) by referring to the lookup table. At first, the description will be oriented to the process for selecting the representative point group neighboring the interpolating object point to be used for the interpolation from the lookup table when starting the interpolation of the compensation amount at the interpolating object point.

First, a value of m that meets the following expression (1) is calculated from the input display data D(p) at the p-th time (where m is an integer of 0 or more meeting the relation of 1×m≦G).
1×m≦D(p)<1×(m+1) (1)

In succession, a value of n that meets the following expression (2) is calculated from the input display data D(q) at the q-th time (where n is an integer of 0 or more meeting the relation of 1×n≦G).
1×n≦D(q)<1×(n+1) (2)
where letting LUT(x,y) be the compensation amount referenced in the lookup table in a case that the display data at the p-th time is a representative value x and the display data at the q-th time is a representative value y, the four representative points A, B, C, D neighboring the interpolating object point is selected as follows.

The compensation amount of the representative point A is calculated by the expression (3). The compensation amount of the representative point C is calculated by the expression (4). The compensation amount of the representative point B is calculated by the expression (5). The compensation amount of the representative point D is calculated by the expression (6).
Ea=LUT(1×m,1×n) (3)
Eb=LUT(1×m,1×(n+1)) (4)
Ec=LUT(1×(m+1),1×(n+1)) (5)
Ed=LUT(1×(m+1),1×n) (6)

The foregoing description has been oriented to the method for selecting the representative points A, B, C D neighboring the interpolating object point and obtaining the compensation amounts Ea, Eb, Ec and Ed of those representative points.

Next, the description will be oriented to the process for calculating a compensation amount Ex of the interpolating object point X by performing an interpolating operation with respect to the compensation amounts Ea, Eb, Ec and Ed of those four representative points.

At first, the interpolating coefficients t and s are defined by the following expressions (7) and (8) and the method for calculating the compensation amount is switched according to the magnitude of the interpolating coefficient t or s.
t=D(p)−1×m (7)
s=D(q)−1×n (8)

An exemplary system of calculating the compensation amount if s≧t is met is illustrated in FIG. 4A.

If s≧t is met, the interpolating operation is performed with respect to three representative points A, B and C of those four points A, B, C and D.

Assuming that E is a point at which a line segment AC is divided internally into a ratio of s:1−s and F is a point at which a line segment AB is divided internally into a ratio of s:1−s, the interpolating object point X corresponds to a point at which a line segment EF is divided internally into a ratio of t:s−t. This thus makes it possible to calculate the compensation amount of the interpolating object point X through the effect of the following expressions (9), (10) and (11), for example.
Ee={(1−s)×Ea+s×Ec}/{(1−s)+s} (9)
Ef={(1−s)×Ea+s×Eb}/{(1−s)+s} (10)

$$\begin{matrix}Ex = \{ ( s - t ) \times Ee + t \times Ef \} / \{ ( s - t ) + t \} \\ = \{ ( 1 - s ) \times Ea + t \times Eb + ( s - t ) \times Ec \} / 1\end{matrix} \qquad ( 11 )$$

On the other hand, an exemplary system of calculating a compensation amount if s<t is met is illustrated in FIG. 4B.

If s<t is met, the interpolating operation is performed with respect to the three representative points A, B and D of those four points A, B, C and D.

Letting H be a point at which a line segment DB is divided internally into a ratio of s:1−s and F be a point at which the line segment AB is divided internally into a ratio of s:1−s, the interpolating object point X corresponds to a point at which a line segment FH is divided internally into a ratio of t−s 1−t. This thus makes it possible to calculate a compensation amount of the interpolating object point X through the effect of the following expressions (10), (12) and (13), for example.
Eh={(1−s)×Ed+s×Eb}/{1−s}+s} (12)

$$\begin{matrix}Ex = \{ ( 1 - t ) \times Ef + ( t - s ) \times Eh \} / \{ ( 1 - t ) + ( t - s ) \} \\ = \{ ( 1 - t ) \times Ea + s \times Eb + ( t - s ) \times Ed \} / 1\end{matrix} \qquad ( 13 )$$

If the compensation amount calculating circuit is made up of digital circuits, it is preferable to select a value of 1 as a power of 2. This is because this selection makes it possible to replace the divisions of the expressions (11) and (13) with a binary shift operation and to reduce the digital circuitry in scale.

As can be seen above, the foregoing description has been oriented to the method for obtaining a compensation amount by performing an interpolating operation with respect to the three representative points through the effect of the systems shown in FIGS. 4A and 4B.

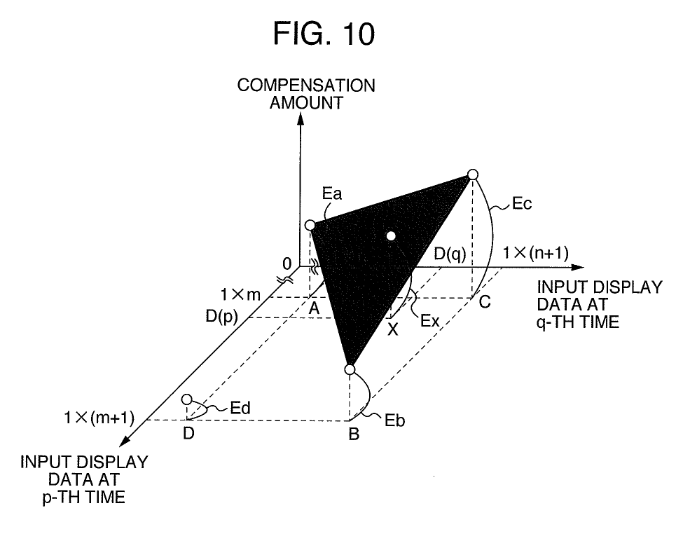

In the meantime, as illustrated in FIG. 10, the expression (11) represents a plane passing through the three points Ea, Eb and Ec in a three-dimensional space with the input display data at the p-th time, the input display data at the q-th time and the compensation amount as its axes. The calculation of the compensation amount Ex thus corresponds to the obtention of a point on the plane that meets the coordinates (D(p), D(q), Ex).

Likewise, the expression (13) represents the plane passing through the three points Ea, Eb and Ed in a three-dimensional space with the input display data at the p-th time, the input display data at the q-th time and the compensation amount as its axes. The calculation of the compensation amount Ex thus corresponds to the obtention of a point on the plane that meets the coordinates (D(p), D(q), Ex) (not shown).

For comparing the interpolating method according to the present invention with the conventional method, the prior art of performing an interpolating operation with respect to four representative points will be described with reference to FIG. 5.

With regard to the process for selecting the representative points A, B, C, D and obtaining the compensation amounts Ea, Eb, Ec, Ed from the lookup table, the foregoing process of the present invention may be applied to the process of the prior art.

In succession, letting E be a point at which the line segment AC is divided internally into a ratio of s:(l−s) and H be a point at which the line segment DB is divided internally into a ratio of s:(l−s), the interpolating object point X corresponds to a point at which a line segment EH is divided internally into a ratio of t:(l−t). This thus makes it possible to calculate a compensation amount of the interpolating object point X through the effect of the expression (14).

$$\begin{matrix}Ex = \{ ( 1 - t ) \times Ee + t \times Eh \} / \{ ( 1 - t ) + t \} \\ = \{ \begin{matrix}( 1 - t ) \times ( 1 - s ) \times Ea + t \times s \times Eb + \\ ( 1 - t ) \times s \times Ec + ( 1 - s ) \times t \times Ed\end{matrix} \} / ( 1 \times 1 )\end{matrix} \qquad ( 14 )$$

For preventing the foregoing occurrence of flickering and gradation shift when displaying a still image, when D(p)=D(q), the compensation amount is required to be zero. In the case of the conventional method of performing an interpolating operation with respect to the four representative points, the expression (14) does not include the constraint wherein the compensation amount is made zero. That is, if the condition (D(p)=D(q)) of a still image, that is, (s=t) and the constraint (Ea=Eb=0) of the compensation amount is substituted in the expression, unlike the expression (15), the compensation amount is not necessarily made zero.
Ex={(l−t)×t×(Ec+Ed)}/(l×l) (15)

Hence, the conventional interpolation about four representative points is required to prepare means for rearranging the compensation amount into a value of 0 as another unit when a still image is displayed, that is, D(p)=D(q) is met. On the other hand, in the case of the interpolation about three representative points according to the present invention, the expressions (11) and (13) have already incorporated the constraint in which the compensation amount necessarily becomes 0 if D(p)=D(q). That is, if the condition (D(p)=D(q)) of a still image, that is, (s=t) and the constraint (Ea=Eb=0) of the compensation amount is substituted in the expressions (11) and (13), both in the expressions (11) and (13), Ex=0 is given. It means that the compensation amount necessarily becomes 0. As set forth above, the interpolating method of the present invention does not need to have a circuit for rearranging a compensation amount. This makes it possible to constitute the display device as simpler circuitry.

Further, in comparing the expression (14) of the conventional interpolating system with the expressions (11) and (13) of the interpolating system according to the present invention, the expression (11) or (13) needs a smaller number of four operations than the expression (14). That is, the former needs a simpler operation system than the latter. This thus makes it possible to constitute the display device as simpler circuitry by applying the interpolating operation of the present invention to the display device in comparison with the circuitry of the display device to which the conventional interpolating operation is applied.

A certain type of display unit 180 like a liquid crystal display unit has a variable response characteristic of lightness of each display element depending upon the magnitude relation between D(p) and D(q). For example, in the liquid crystal display unit, the physical phenomenon that contributes to the response characteristic of lightness in D(p)>D(q) is different from that in D(p)<D(q). It is preferable that the display device provided with this type of display unit is designed to switch the interpolating operation depending upon the magnitude relation between D(p) and D(q). This variance becomes quite remarkable if the value of D(p) is very close to the value of D(q), for example, if m=n is met in the expression (7) or (8).

The conventional interpolating method indicated in the expression (14) does not provide a capability of switching the operating expression according to the magnitude relation between D(p) and D(q), while the interpolating method of the present invention indicated in the expressions (11) and (13) provides a capability of easily switching the operating expression according to the magnitude relation between D(p) and D(q) (the magnitude relation between t and s if m=n is met). That is, the interpolating method of the present invention is more applicable to the display unit 180 that has a variable response characteristic of lightness of each display element depending upon the magnitude relation between D(p) and D(q), such as the liquid crystal display unit, than the conventional interpolating method.

As set forth above, the display device to which the present invention is applied may be reduced in circuit scale and in number of parts and supplied less costly in comparison with the conventional display device.

The description about the interpolating operation has concerned with the selection of the three representative points used for interpolation as A, C, B or A, B, D according to the values of the interpolating coefficients t and s. In place, depending upon the way of use of the compensating circuit or the characteristic of the display unit, the selection of the three representative points may be properly switched into A, C, D or C, B, D according to the value of the interpolating coefficients t and s or other factors such as the values of D(p) and D(q).

### Second Embodiment

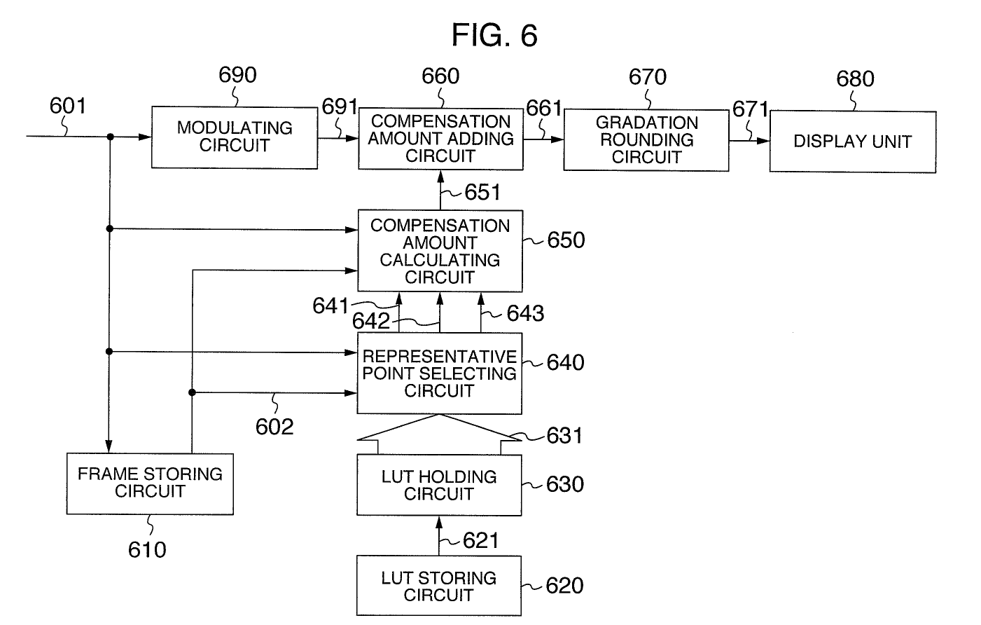

Hereafter, the second embodiment of the present invention will be described with reference to FIG. 6.

FIG. 6 is a circuit diagram showing a configuration of a display device to which the second embodiment of the present invention is applied.

The display device provides a capability of being supplied as its input with the input display data 601 and displaying the lightness and colors corresponded with the gradation of the input display data. The input display data 601 is transferred from an external device (for example, a signal processing device included in electronic apparatuses including a TV receiver, a personal computer and a cellular phone.

The display device is designed to have a data delay circuit 610, an LUT storing circuit 620, an LUT holding circuit 630, a representative point selecting circuit 640, a compensation amount calculating circuit 650, a compensation amount adding circuit 660, a gradation rounding circuit 670, a display unit 680, and a modulating circuit 690. The configuration of the display device is similar in function to that of the first embodiment except the modulating circuit 690.

The modulating circuit 690 is a circuit that performs various modulations about the input display data 601 and outputs the modulated display data 691. The modulating circuit is designed to divide an updating period of the input display data 601, for example, into k parts (k being an integer of 2 or more) and to output the input display data 601 as the modulated display data 691 k times within one updating period of the input display data 601. This modulation is called the k-times faster modulation. Each circuit located after the modulating adding circuit 660 being supplied as input with the modulated display data 691 is preferably designed to be operated at k-times speed according to the modulated display data 691.

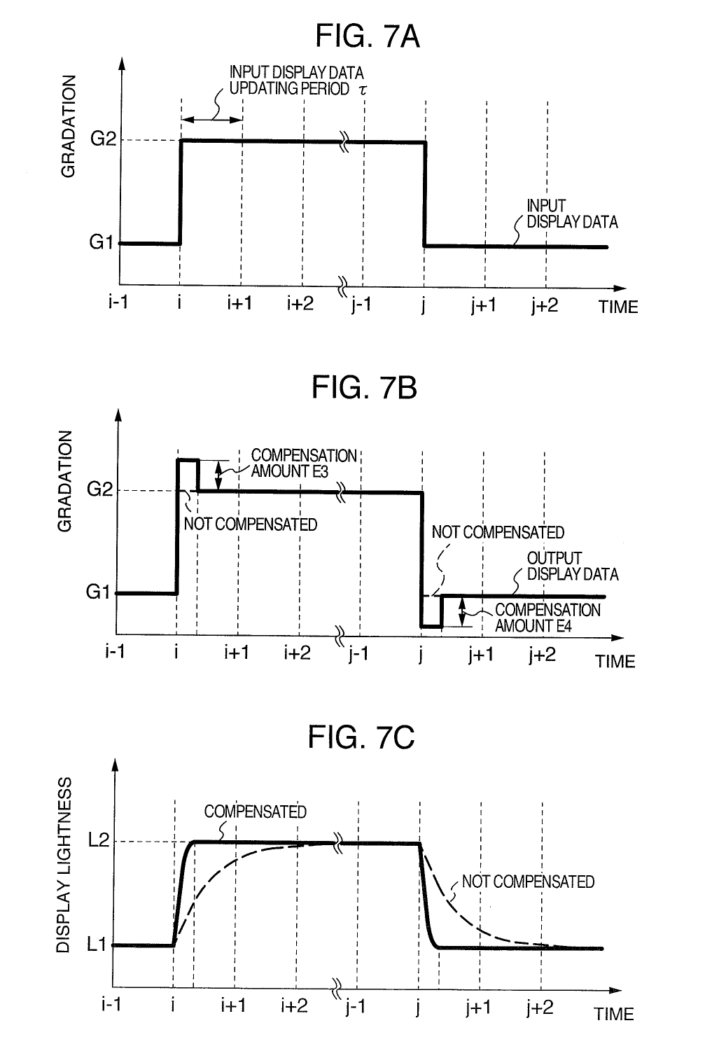

FIG. 7 shows change of the input display data and the lightness of the display unit in the case of applying the present invention to the display device provided with the k-times faster modulation.

FIG. 7A is a graph showing change of the input display data to be inputted to a unit of display unit of the display device, which is the same as the change shown in FIG. 2A. Then, FIG. 7B shows change of the output display data in the case of applying the enhancement drive system to the display device provided with a function of modulating the input display data shown in FIG. 7A at k-times speed or not (that is, in the presence or absence of compensation).

The waveform shown by a solid line represents the change of the output display data appearing in the case of applying the k-times faster modulation drive and the enhancement drive to the display device. On the other hand, the waveform shown by a broken line represents the change of the output display data appearing when only the k-times faster modulation is applied to the display device.

The display device provided with the k-times faster modulating circuit has a capability of setting the updating period of the output display data to τ/k if τ is let to be the updating period of the input display data. It means that if the compensating circuit, for example, for the enhancement drive system is built in the display device, the compensation of the input display data can be carried out in a shorter period. Or, the compensation can be carried out more times within the same length of time. This makes it possible for the k-times faster modulation to realize more fine modulation than the modulation of the normal drive, thereby being able to improve the image quality of the display screen.

In FIG. 7B, in the enhancement drive system, the gradation of the input display data is changed from G1 to G2 at the i-th frame. Hence, the compensation amount E3 for stressing this change is added. The period when the compensation amount E3 is added may be shorter than the updating period τ of the input display data. Further, since the gradation is changed from G2 to G1 at the j-th frame, the compensation amount E4 for stressing this change is added. Herein, the period when the compensation amount E4 is added may be shorter than the updating period τ of the input display data. On the other hand, in the case of the normal drive shown by a broken line, the output display data is matched to the input display data (before being compensated).

In turn, the description will be oriented to an example of a response characteristic of lightness of a unit of display of the display device with respect to the output display data.

FIG. 7C shows the change of lightness of a unit of display of the display device with respect to the output display data shown in FIG. 7B.

The response of lightness to the k-times faster modulated and compensated output display data is plotted by a solid line. The response of lightness to only the normal driven output display data is plotted by a broken line. In the response of lightness in the normal drive indicated by a broken line, the display lightness is started to change from the lightness L1 to the lightness L2 at the i-th frame. However, even at the (i+1)-th frame, the display lightness does not reach the lightness L2. On the other hand, in the response of lightness in the case of building the enhancement drive system in the display device as indicated by a solid line, at the i-th frame, the display lightness is started to change from the lightness L1 to the lightness L2. Before the (i+1)-th frame, the display lightness reaches the target lightness L2.

As described above, if the display lightness does not reach the target lightness within the updating period τ in the normal drive system display device, by building the k-times faster modulation drive system and the enhancement drive system for adding a proper compensation amount in the display device, the display lightness comes to reach the target lightness within the updating period τ. It means that the apparent response time of the display devic may be reduced. This makes it possible to improve the quality of a moving image on the display unit. It is preferable that the compensation amount E3 of the second embodiment is greater than the compensation amount E1 of the first embodiment. The integral value of the compensation amount E3 of the second embodiment may be equal to the integral value of the compensation amount E1 of the first embodiment.

As shown in FIG. 7B, it is preferable to add the compensation amounts E3 and E4 within the first divisional period of the i-th frame. In a case that the first divisional period of the output display data is greater than the maximum value (for example, all bits being one (1)) of the output display data as a result of adding the compensation amount E3 within the first divisional period of the input display data, it is preferable to add the remaining compensation amount to the input display data of the second divisional period or later. In a case that the first divisional period of the output display data is smaller than the minimum value (for example, all bits being zero (0)) of the output display data as a result of adding the compensation amount E4 to the input display data of the first divisional period, it is preferable to add the remaining compensation amount to the input display data of the second divisional period or later.

### Third Embodiment

The display device according to the third embodiment of the present invention may take the configuration of the display device according to the second embodiment thereof, and thus the description thereabout is left out.

The difference of the display device according to the third embodiment from the display device according to the second embodiment is a modulating method to be executed in the modulating circuit 690.

For example, the modulating circuit 690 is composed of the so-called impulse modulating circuit, which divides the updating period τ of the input display data into plural periods, modulates the modulated display data so that the data is greater than or equal to the input display data during at least one of those divisional periods or so that the data is smaller than or equal to the input display data, and outputs the modulated data as the output display data.

Herein, the impulse modulation will be described below. If the display device is classified from a view of moving image display, the display device is roughly divided into an impulse system display device and a hold system display device. The impulse system display device is designed so that the pixels increase their lightness only in the scanning interval and lower their lightness after the scan like a cathode-ray tube, while the hold system display device is designed so that the pixels hold their lightness based on the display data from the current scan to the next scan like a liquid crystal display.

The hold system display device has a shortcoming that the area around a moving object becomes blur if a moving image is displayed though excellent display quality can be obtained with no flickering if a still image is displayed, that is, the so-called blurredness phenomenon of the moving image appears and thus the display quality is made remarkably degraded. This blur moving image results from the so-called afterimage on watcher's retinas brought about when a watcher interpolates the display images before and after movement with respect to the display image whose lightness is held when the watcher's eyes are moving with movement of an object. Hence, however much the response speed of the display device may be improved, the blurredness on the moving image cannot be completely eliminated.

In order to overcome this shortcoming, it is effective to take the method in which the luminous characteristic of the hold system display device comes closer to that of the impulse system display device by erasing the afterimage on watcher's retinas once by inserting a black image. The impulse modulation is one of the method for making the luminous characteristic of the hold system display device closer to that of the impulse system display device.

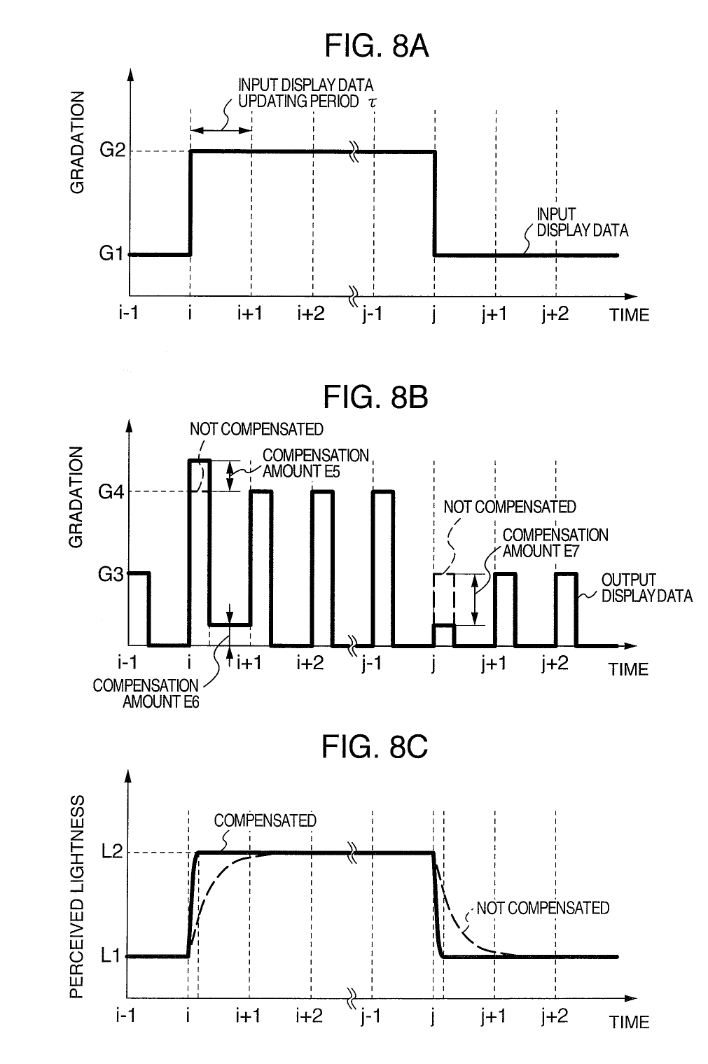

FIG. 8 exemplarily shows change of lightness of the display device and the input display data appearing in the case of applying the present invention to the display device provided with the impulse modulation.

FIG. 8A is a graph exemplarily showing change of the input display data being inputted on a unit of display of the display device, which is the same as that shown in FIG. 2A. Then, FIG. 8B is a graph exemplarily showing change of the output display data shown in FIG. 8A appearing in the case of impulse-modulating the input display data and applying the enhancement drive to the display device, that is, the change of the compensated output display data.

The waveform shown by a solid line represents the change of the output display appearing in the case of applying both the impulse modulation and the enhancement drive to the display device. On the other hand, the waveform shown by a broken line represents the change of the output display data appearing in the case of applying only the impulse modulation to the display device. For the normal impulse modulation shown by a broken line, for example, in a case that the input display data is G1, the display data is modulated so that the modulated data becomes the gradation G3 that exceeds the gradation G1 during at least one of the divisional updating periods and so that the modulated data becomes the gradation 0 that is less than the gradation G1 during at least another one thereof. For example, if the input display data has another gradation, the similar method is used for the modulation.

As described above, the impulse modulation is executed to divide the updating period τ into plural parts and modulate the data during each divisional period. In each period, the compensating circuit operates to compensate the data. To the compensating circuit may be applied the enhancement drive system. This thus makes it possible to for the impulse modulation drive to more fine compensate the data than the normal drive, thereby being able to improve the display quality of a moving image.

In the waveform shown in FIG. 8B, since the gradation of the input display data is changed from G1 to G2 at the i-th frame, the compensation amount E5 for compensating this change is added to the display data. The time when the compensation amount E5 is added corresponds to one divisional period. Further, in another divisional period, the compensation amount E6 may be added to the display data. The compensation amount E6 is also added for compensating the change of the gradation of the input display data at the i-th frame from G1 to G2.

Further, since the gradation of the input display data is changed from G2 to G1 at the j-th frame, the compensation amount E4 for stressing this change is added to the period. The period when the compensation amount E4 is added corresponds to a part of the divisional updating period. In another divisional updating period, the compensation amount E7 may be added or not. The compensation amount is properly set so that the display device may obtain an intentional luminous characteristic. Then, the description will be oriented to an example of a response characteristic of lightness of each unit of display corresponding with the output display data.

FIG. 8C is a model graph showing change of lightness perceived by a watcher as changing lightness of a unit of display with respect to the output display data shown in FIG. 8B. The change of lightness is plotted in consideration of the afterimage on watcher's retinas.

The response of lightness to the impulse-modulated and compensated output display data is plotted by a solid line, while the response of perceived lightness to the impulse-modulated (but not compensated) output display data is plotted by a broken line.

As is shown in the graph of FIG. 8C, the change of the perceived lightness appearing in the case of applying both the impulse modulation and the enhancement drive to the output display data may be made more acute than the change of the perceived lightness appearing in the case of applying only the impulse modulation thereto. This makes it possible to suppress the blurredness phenomenon of the moving image and improve the display quality of the moving image of the display device.

In the case of applying both the impulse modulation and the enhancement drive, a plurality of lookup tables for storing properly calculated compensation amounts are prepared and in each of plural divisional periods, one of those lookup tables is selected for calculating the compensation amount. This configuration makes it possible to more fine control the perceived lightness and further improve the display quality.

The display device to which the present invention is applied may be designed to have plural modulating circuits so that the modulation is carried out as properly switching those modulating circuits. Further, the display device is also designed so that a plurality of lookup tables each for storing the compensation amount properly calculated according to the characteristic of each modulating circuits and those lookup tables may be switchably selected for each of the modulating circuits.

The present invention is applicable to a liquid crystal TV set as well.

It should be further understood by those skilled in the art that although the foregoing description has been made on embodiments of the invention, the invention is not limited thereto and various changes and modifications may be made without departing from the spirit of the invention and the scope of the appended claims.

1. A display device being supplied with image data having plural gradations as input display data and performing a display based on the plural gradations of the input display data through the effect of lightness levels having been corresponded with the input display data, comprising:
a compensating circuit for compensating data to be outputted for display on the basis of a temporal change in the input display data;
a storing circuit for storing a lookup table that saves pre-calculated compensation amounts of representative temporal changes as representative compensation amounts for compensating the output display data; and
if the compensation amount is calculated on the temporal change in the input display data, the compensating circuit serving to select a first to a third representative compensation amounts from the lookup table and to calculate the compensation amount from the three representative compensation amounts through the use of a function operation.

2. The display device as claimed in claim 1, wherein when calculating the compensation amount from the first to the third representative amounts through the use of the function operation, if a first representative point Ea corresponding with the first representative compensation amount, a second representative point Eb corresponding with the second representative compensation amount, and a third representative point Ec corresponding with the third representative compensation amount are plotted on a three-dimensional space having input image data D(p) at p time, input image data D(q) at q time, and a compensation amount E(p, q, r) at r time as its axes, the compensation amount E(p, q, r) of an interpolating object point except the representative points is obtained on the plane passing through the three representative points by performing an interpolating operation.

3. The display device as claimed in claim 2, wherein letting Ea, Eb and Ec be the representative compensation amounts of the three representative points respectively, a compensation amount Ex of the interpolating object point is calculated by the expression of Ex=α×Ea+β×Eb+γ×Ec (α, β, γ being interpolating coefficients).

4. A display device being supplied with image data having plural gradations as input display data and performing a display based on the plural gradations of the input display data through the effect of lightness levels having been corresponded with the input display data, comprising:
a compensating circuit for calculating from input display data D(p) at p (p being an integer of 1 or more) time and input display data D(q) at q (q being an integer of 1 or more) time a compensation amount E(p, q, r) at r (r being a positive number) time to be used for compensating input display data D(q) and compensating the input display data D(q) at q time with the compensation amount, for obtaining the output display data D(r) at r time;
a storing circuit for pre-storing a lookup table consisting of N rows and N columns in which letting G (G being an integer of 1 or more) be the number of gradations to be accepted or displayed as the input display data, representative N (N being an integer of 1 or more) gradations selected from the G gradations are specified as a representative gradation group, a representative point is specified if the input display data D(p) at p time is any gradation belonging to the representative gradation group and the input display data D(q) at q time is any gradation belonging to the representative gradation group, the representative point group consists of N×N points, the compensation amount at the representative point is specified as a representative compensation amount, and the representative compensation amount group consists of N×N, the representative compensation amount group is per-calculated by a predetermined method so that the display device shows an intentional display characteristic and the representative compensation amount consisting of N×N is pre-stored in the lookup table itself;
when calculating a compensation amount E(p, q, r) at r (r being a positive number) time for compensating the input display data D(q) at q time from the input display data D(p) at p time and the input display data D(q) at q time, if the input display data D(p) at p time belongs to the representative gradation group and the input display data D(q) at q time belongs to the representative gradation group, the compensating circuit serving to obtain the compensation amount E(p, q, r) by referring to the lookup table and compensate the input display data D(q) through the use of the compensation amount E(p, q, r);
if neither of the input display data D(p) at p time and the input display data D(q) at q time belong to the representative gradation group or one of them does not belong to the representative gradation group, the compensating circuit serving to select plural representative compensation amount groups from the lookup table, calculate the compensation amount E(p, q, r) from the representative compensation amount groups, compensate the input display data D(q) through the use of the compensation amount E(p, q, r); and
if neither of the input display data D(p) at p time and the input display data D(q) at q time belong to the representative gradation group or one of them does not belong to the representative gradation group, the compensating circuit serving to select three representative compensation amount groups from the lookup table when performing the interpolating operation.

5. The display device as claimed in claim 4, wherein the representative gradation number N is smaller than the number G of gradations to be accepted or displayed as the input display data.

6. The display device as claimed in claim 4, further comprising:
a display panel having as units of display ranged thereon;
a first driving circuit for outputting to the pixels a display signal corresponding with the input display data; and
a second driving circuit for outputting a selection signal for selecting the pixels to which the display signal is to be supplied to the pixels.

7. The display device as claimed in claim 6, wherein the compensating circuit provides a modulating circuit for modulating the input display data, for generating modulated display data; and
the modulating circuit divides an updating period of the input display data into k parts (k being an integer of 1 or more) and outputs the input display data as the modulated display data k times within one updating period of the input display data.

8. The display device as claimed in claim 6, wherein the compensating circuit provides a modulating circuit for modulating the input display data, for generating modulated display data, and
the modulating circuit divides an updating period of the input display data into plural parts, modulates the input display data in the plural parts so that the modulated display data becomes greater than or equal to the input display data during at least one divisional period and so that the modulated display data becomes smaller than or equal to the input display data during at least another divisional period.

9. The display device as claimed in claim 6, wherein the compensating circuit provides a lookup table storing circuit for storing the lookup table and a lookup table holding circuit for reading the lookup table from the lookup table storing circuit and holding the read lookup table,
the interpolating operation is carried out by referring to the lookup table held in the lookup table holding circuit, and
the lookup table stored in the lookup table storing circuit is structured to be rewritten.

10. The display device as claimed in claim 9, wherein the lookup table storing circuit stores plural lookup tables, and when reading the lookup table from the lookup table storing circuit, a proper one of those lookup tables is selectively read out.

11. The display device as claimed in claim 1, wherein the display device is a liquid crystal display device.

12. The display device as claimed in claim 1, wherein the display device is an organic EL (Electro Luminescence) display device.

13. The display device as claimed in claim 1, wherein the display device is a PDP (Plasma Display Panel) display device.

14. A display device for displaying gradations on a plurality of pixels ranged in matrix on the basis of input display data, comprising:
a storing circuit for storing a table including compensation amounts defined to correspond with first display data and second display data; and
a compensating circuit for calculating compensation amounts corresponding with input display data at the i-th frame (i being an integer) and input display data at the (i+n)-th frame (n being an integer of 1 or more) by referring to the table and compensating the input display data at the (i+n)-th frame with the compensation amounts, and wherein
the first and the second display data take representative values to be taken by the input display data, and
if the input display data at the i-th frame does not correspond with the first display data and the input display data at the (i+n)-th frame does not correspond with the second display data, the compensating circuit selects three of two compensation amounts corresponding with the two first display data items located above and under the input display data at the i-th frame and two compensation amounts corresponding with the two second display data items located above and under the input display data at the (i+n)-th frame and operates a compensation amount for compensating the input display data at the (i+n)-th frame based on those three compensation amounts.

15. The display device as claimed in claim 14, wherein the compensating circuit selects the three compensation amounts for the first display data and the second display data corresponding with smaller three differences of two differences between the input display data at the i-th frame and the first display data item located thereabove and between the input display data at the i-th frame and the first display data item located thereunder and two differences between the input display data at the (i+n)-th frame and the second display data item located thereabove and the input display data at the (i+n)-th frame and the second display data item located thereunder.

16. The display device as claimed in claim 14, wherein the compensating circuit calculates a weighted average of those three compensation amounts according to the three differences and operates a compensation amount to be used for compensating the input display data at the (i+n)-th frame.

17. The display device as claimed in claim 14, further comprising a modulating circuit for outputting the input display data k times (k being an integer of 2 or more) in one frame interval and wherein the compensating circuit adds the compensation amount for compensating the input display data at the (i+n)-th frame to the first input display data item to the k-th input display data item in sequence without departing from a maximum value and a minimum value of the input display data.

18. The display device as claimed in claim 14, further comprising a modulating circuit for converting the input display data into greater display data and smaller display data than the input display data and outputs the greater display data and the smaller display data on time series and wherein the compensating circuit adds the compensation amount for compensating the input display data at the (i+n)-th frame to the first display data item of the greater and the smaller display data and the subsequent display data items thereof in sequence without departing from a maximum value and a minimum value of the input display data.
